(19) United States
(12) Patent Application Publication
(10) Pub. No.: US 2014/0325408 A1
(43) Pub. Date: Oct. 30, 2014

(54) APPARATUS AND METHOD FOR PROVIDING MUSICAL CONTENT BASED ON GRAPHICAL USER INPUTS

(71) Applicant: NOKIA CORPORATION, Espoo (FI)

(72) Inventors: Jussi Leppanen, Tampere (FI); Arto Juhani Lehtiniemi, Lempaala (FI); Antti Johannes Eronen, Tampere (FI)

(73) Assignee: Nokia Corporation, Espoo (FI)

(21) Appl. No.: 13/871,265

(22) Filed: Apr. 26, 2013

(51) Int. Cl. G06F 3/0481

(52) U.S. Cl. CPC G06F 3/0481
USPC 715/765

(57) ABSTRACT

Mechanisms are provided for receiving a graphical input from a user, such as a sketch, determining at least one musical element represented by the graphical input, identifying at least one item of musical content including the musical element(s), and providing for presentation of the at least one item of musical content to the user, such as by creating a playlist for the user of the identified content. Certain musical elements represented in the graphical input may be emphasized or deemphasized to indicate a dominance of the particular musical element in the desired musical content. The graphical input may be modified by the user to allow the user to iteratively search for music in a dynamic, real-time manner.

### TECHNOLOGICAL FIELD

Example embodiments of the present invention relate generally to providing musical content in response to receiving graphical user inputs.

### BACKGROUND

In this age of information, users of electronic devices, such as personal computers, mobile devices, tablet computers, and so on, can access vast amounts of data virtually any time, from anywhere. With so much content available, it is sometimes difficult to identify and provide the particular content desired by a user.

With respect to musical content such as music files, a user may wish to create a playlist containing only certain songs or a certain genre of music. As the user consumes the music on his playlist, he may want to modify the playlist so as to add or delete certain songs from his playlist.

### BRIEF SUMMARY OF EXAMPLE EMBODIMENTS

Accordingly, embodiments of an apparatus, method, and computer program product are described that can provide musical content meeting certain user-defined criteria for presentation to the user based on graphical inputs provided by the user that represent one or more desired musical elements. In particular, embodiments of an apparatus for providing musical content based on graphical user inputs may include at least one processor and at least one memory including computer program code. The at least one memory and the computer program code may be configured to, with the processor, cause the apparatus to at least receive a graphical input provided by a user, wherein the graphical input represents at least one musical element; to determine the at least one musical element represented by the graphical input; to identify at least one item of musical content including the at least one musical element determined; and to provide for presentation of the at least one item of musical content to the user.

The at least one musical element may comprise a musician, a musical instrument, and/or a musical style. In addition, the graphical input may represent a dominance of the at least one musical element. The at least one memory and the computer program code may be configured to, with the processor, cause the apparatus to identify the at least one item of musical content by accessing a database configured to store a plurality of items of musical content and matching an input tag associated with a musical element represented by the graphical input with a content tag associated with the at least one item of musical content stored in the database. The at least one memory and the computer program code may be configured to, with the processor, cause the apparatus to provide for the presentation of the at least one item of musical content by displaying a playlist.

In some embodiments, the at least one memory and the computer program code may be configured to, with the processor, cause the apparatus to receive the graphical input by receiving a modification of the graphical input provided by the user. The at least one memory and the computer program code may further be configured to, with the processor, cause the apparatus to provide for display of a graphical representation of at least one musical element of an initial item of musical content that is provided to the user. Receiving the graphical input may comprise receiving a modification of the graphical representation. Additionally or alternatively, the at least one memory and the computer program code may be further configured to, with the processor, cause the apparatus to provide for communication of the graphical input and the at least one item of musical content identified to a remote device.

In other embodiments, a method and a computer program product are described for receiving a graphical input provided by a user, wherein the graphical input represents at least one musical element; determining the at least one musical element represented by the graphical input; identifying at least one item of musical content including the at least one musical element determined; and providing for presentation of the at least one item of musical content to the user.

The at least one musical element may comprise a musician, a musical instrument, or a musical style, and the graphical input may represent a dominance of the at least one musical element. In some cases, the at least one item of musical content may be identified by accessing a database configured to store a plurality of items of musical content and matching an input tag associated with a musical element represented by the graphical input with a content tag associated with the at least one item of musical content stored in the database. Additionally or alternatively, embodiments of the method and computer program product may provide for the presentation of the at least one item of musical content by displaying a playlist.

In some embodiments, the graphical input may be received by receiving a modification of the graphical input provided by the user. Moreover, embodiments may provide for display of a graphical representation of at least one musical element of an initial item of musical content that is provided to the user, wherein receiving the graphical input comprises receiving a modification of the graphical representation. Additionally or alternatively, embodiments of the method and computer program produce may provide for communication of the graphical input and the at least one item of musical content identified to a remote device.

In still other embodiments, an apparatus is described for providing items of musical content to a user. The apparatus includes means for receiving a graphical input provided by a user, wherein the graphical input represents at least one musical element; means for determining the at least one musical element represented by the graphical input; means for identifying at least one item of musical content including the at least one musical element determined; and means for providing for presentation of the at least one item of musical content to the user.

### BRIEF DESCRIPTION OF THE SEVERAL VIEWS OF THE DRAWING(S)

Having thus described certain example embodiments of the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for providing items of musical content according to an example embodiment of the present invention;

FIG. 3 illustrates a display of an apparatus depicting a graphical input representing a single musical element according to an example embodiment of the present invention;

FIG. 4 illustrates a display of an apparatus depicting a graphical input representing two musical elements according to an example embodiment of the present invention;

FIG. 5 illustrates a display of an apparatus depicting a graphical input representing three musical elements according to an example embodiment of the present invention;

FIG. 6 illustrates a display of an apparatus depicting a modification of a graphical input removing one of the represented musical elements according to an example embodiment of the present invention;

FIG. 7 illustrates a display of an apparatus depicting a graphical input representing three musical elements, where one of the musical elements is indicated as being more dominant than the other two via a larger size according to an example embodiment of the present invention;

FIG. 8 illustrates a display of an apparatus depicting a graphical representation of three musical elements according to an example embodiment of the present invention;

FIG. 9 illustrates a system for providing musical content to a user according to an example embodiment of the present invention; and

FIG. 10 illustrates a flowchart of methods of providing items of musical content to a user according to example embodiments of the present invention.

### DETAILED DESCRIPTION

Some example embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

As noted above, advancements in technology have made vast quantities of various types of content, including musical content, available to users. To navigate such content and identify the particular content items that may be of interest to the user, inputs may be received from the user that are informative as to a particular quality or characteristic of the content that the user is seeking.

With respect to musical content, for example, a user may wish to create a playlist of certain music files, such as songs or music videos, for consumption by the user and/or for sharing with other users. The user may wish to include on his playlist only songs that meet a certain criterion or set of criteria. For example, the user may want to include only musical content that has one or more particular musical elements. Thus, in one example, the user may desire to include on his playlist only songs that include vocals performed by a certain musician. In another example, the user may wish to include only songs that include a particular instrument, such as an electric guitar, or combination of instruments, such as an electric guitar and a viola.

As the playlist is being sampled or consumed, the user's mood may change, or a particular song that he is listening to may evoke new feelings that cause the user to want to modify the playlist to include musical content that satisfies additional or different criteria. For example, the user may want to hear songs that include not only electric guitar and viola, but also bongo drums. Thus, the user may need to dynamically modify the group of musical content items being provided to him (e.g., as the group of musical content items is being experienced).

At the same time, the user may be a creative fellow who would prefer to hand-sketch his desired musical criteria, rather than provide text input such as keywords. Thus, rather than type in a search term such as “guitar,” the user may instead by inclined to draw a picture of a guitar or a musician playing a guitar.

Accordingly, example embodiments of the present invention provide mechanisms for receiving a graphical input from a user, such as a sketch, determining at least one musical element represented by the graphical input, identifying at least one item of musical content including the musical element(s), and providing for presentation of the at least one item of musical content to the user, such as by creating a playlist for the user of the identified content. Certain musical elements represented in the graphical input may be emphasized or deemphasized to indicate a dominance of the particular musical element in the desired musical content. The graphical input may be modified by the user, resulting in a modified playlist. In some cases, the user may be presented with a graphical representation of a particular song or playlist, which may then be modified by the user to customize and refine the playlist to the user's tastes. Graphical inputs and the musical content associated with the inputs may be shared with other users and collaboratively modified. In this way, users are able to iteratively search for music in a creative, dynamic, and real-time manner.

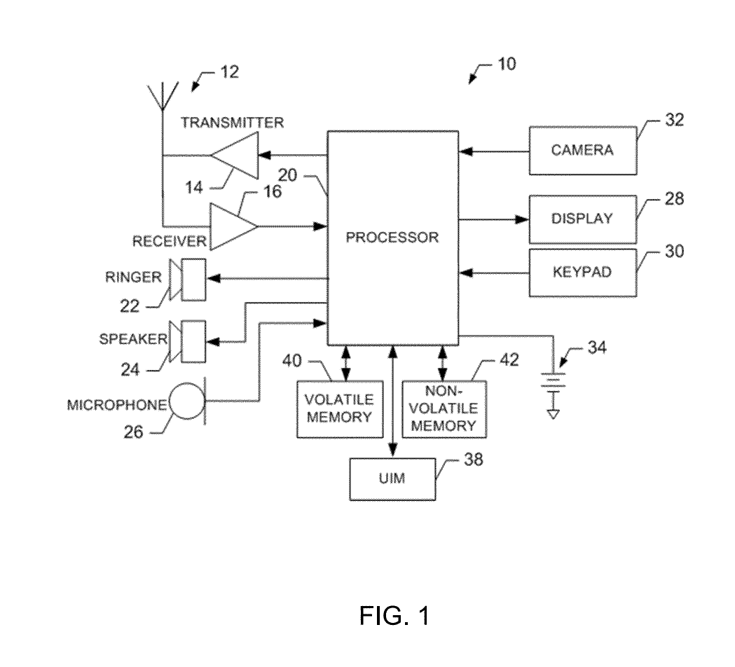

FIG. 1, which provides one example embodiment, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as personal digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments. In some embodiments, for example, fixed (non-mobile) devices that may benefit from the embodiments described herein may include household appliances, such as refrigerators incorporating a touch screen and configured for WiFi connectivity.

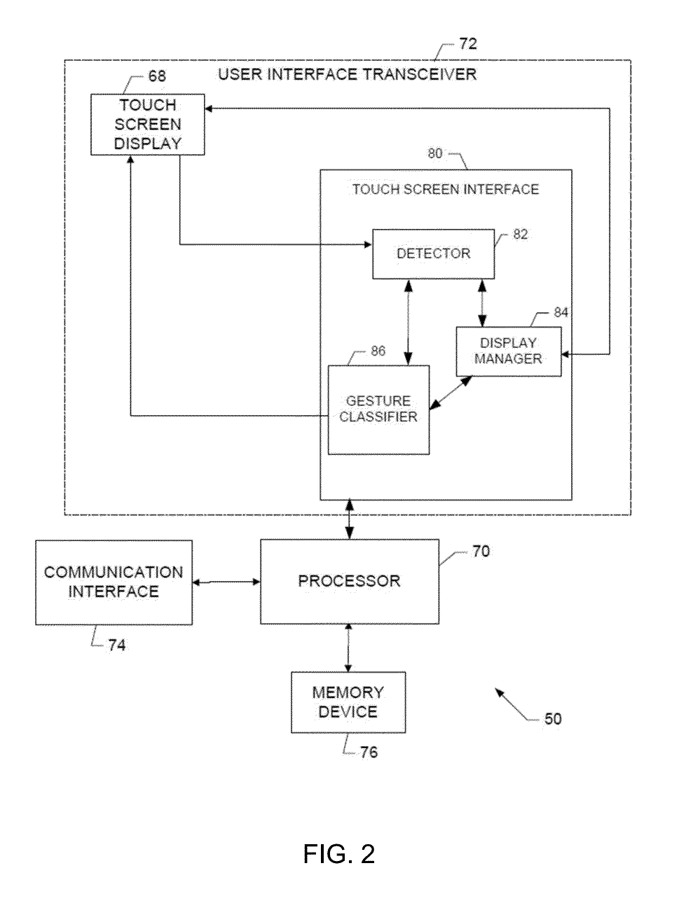

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element 32 in order to capture images or video of objects, people, and places proximate to the user of the mobile terminal 10. The mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the invention will now be described with reference to FIG. 2, which depicts certain elements of an apparatus 50 for providing items of musical content for presentation to a user. The apparatus 50 of FIG. 2 may be employed, for example, with the mobile terminal 10 of FIG. 1. However, it should be noted that the apparatus 50 of FIG. 2 may also be employed in connection with a variety of other devices, both mobile and fixed, and therefore, embodiments of the present invention should not be limited to application on devices such as the mobile terminal 10 of FIG. 1. For example, the apparatus 50 may be employed on a personal computer, a tablet, a mobile telephone, a mobile computing device, or other user terminal. Moreover, in some cases, part or all of the apparatus 50 may be on a fixed device such as server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus for providing items of musical content for presentation to a user, numerous other configurations may also be used to implement embodiments of the present invention. As such, in some embodiments, although devices or elements are shown as being in communication with each other, hereinafter such devices or elements should be considered to be capable of being embodied within a same device or element and, thus, devices or elements shown in communication should be understood to alternatively be portions of the same device or element.

Referring now to FIG. 2, the apparatus 50 for providing items of musical content for presentation to a user may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, and/or other techniques. The user interface transceiver 72 may be in communication with the touch screen display 68 to receive touch inputs at the touch screen display 68 and to analyze and/or modify a response to such indications based on corresponding user actions that may be inferred or otherwise determined responsive to the touch inputs.

With continued reference to FIG. 2, in an example embodiment, the apparatus 50 may include a touch screen interface 80. The touch screen interface 80 may, in some instances, be a portion of the user interface transceiver 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an input in the form of a touch event at the touch screen display 68. As such, the touch screen interface 80 may be in communication with the touch screen display 68 to receive user inputs at the touch screen display 68 and to modify a response to such inputs based on corresponding user actions that may be inferred or otherwise determined responsive to the inputs. Following recognition of a touch event, the touch screen interface 80 may be configured to determine a classification of the touch event and provide a corresponding function based on the touch event in some situations. In some cases, the input may be in the form of a hovering event, where the input is detected due to proximity of the user's finger or other object to the touch screen display 68 without requiring actual contact with the display.

In some embodiments, the touch screen interface 80 may include a detector 82, a display manager 84, and a gesture classifier 86. Each of the detector 82, the display manager 84, and the gesture classifier 86 may be any device or means embodied in either hardware or a combination of hardware and software configured to perform the corresponding functions associated with the detector 82, the display manager 84, and the gesture classifier 86, respectively, as described herein. In an example embodiment, each of the detector 82, the display manager 84, and the gesture classifier 86 may be controlled by or otherwise embodied as the processor 70.

The detector 82 may be in communication with the touch screen display 68 to receive user inputs in order to recognize and/or determine a touch event based on each input received at the detector 82. A touch event may be defined as a detection of an object, such as a stylus, finger, pen, pencil, cellular telephone, digital camera, or any other mobile device (including the mobile terminal 10 shown in FIG. 1) or object, coming into contact with a portion of the touch screen display in a manner sufficient to register as a touch. In this regard, for example, a touch event could be a detection of pressure on the screen of the touch screen display 68 above a particular pressure threshold over a given area. Subsequent to each touch event, the detector 82 may be further configured to pass along the data corresponding to the touch event (e.g., location of touch, length of touch, number of objects touching, touch pressure, touch area, speed of movement, direction of movement, length of delay, frequency of touch, etc.) to the gesture classifier 86 for gesture classification. As such, the detector 82 may include or be in communication with one or more force sensors configured to measure the amount of touch pressure (e.g., force over a given area) applied as a result of a touch event, as an example.

The gesture classifier 86 may be configured to recognize and/or determine a corresponding classification of a touch event. In other words, the gesture classifier 86 may be configured to perform gesture classification to classify the touch event as any of a number of possible gestures. Some examples of recognizable gestures may include a touch, multi-touch, stroke, character, symbol, shape, pinch event (e.g., a pinch in or pinch out), and/or the like.

In some embodiments, for example, the user may provide one or more touch inputs that create a shape or collection of shapes that may be recognizable (e.g., by the gesture classifier 86) as representative of a particular person or object. Thus, for example, the user may provide a graphical input via the touch screen display 68 that is recognizable as representative of a particular musical instrument or musician based on an analysis of constituent shapes as compared, for example, to a database of shapes and/or based on the arrangement of shapes with respect to each other. In this way, the gesture classifier 86 may be configured to classify the touch event(s) provided by a user in creating a sketch or scene of certain desired musical elements as certain shapes, and such shapes may be determined (e.g., via the processor 70) as representative of one or more particular musical elements, as described in greater detail below.

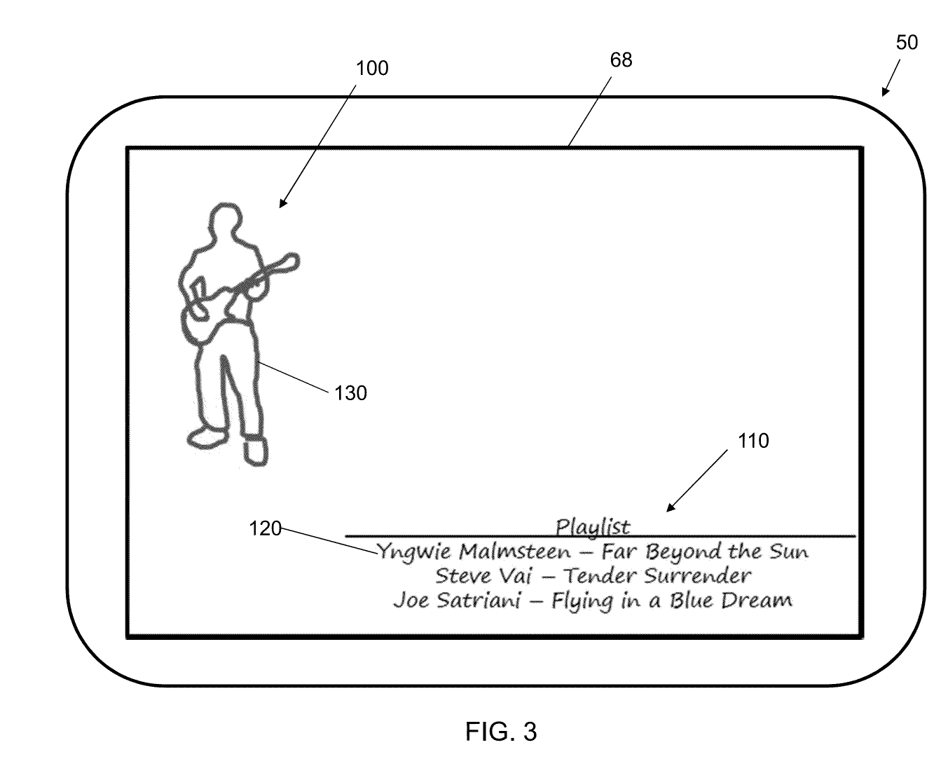

Turning now to FIG. 3, in general, an apparatus 50 is provided, such as an apparatus embodied by the mobile terminal 10 of FIG. 1 (e.g., a tablet computer) that has or is otherwise associated with a display, such as a touch screen display 68. As described above, the apparatus 50 may comprise at least one processor (e.g., processor 70 of FIG. 2) and at least one memory (e.g., memory device 76 of FIG. 2) including computer program code. The at least one memory and the computer program code may be configured to, with the processor, cause the apparatus 50 to execute various functions to provide items of musical content for presentation to a user.

As mentioned above, a user may wish to create a playlist or other grouping of musical content items meeting certain criteria. For example, the user may want to gain access to songs that are played by a solo guitarist. To convey the desired criteria, the user may draw a sketch 100 (e.g., via the touch screen display 68 of FIG. 2) of a single person playing the guitar, as shown in FIG. 3. The sketch 100 may thus serve as a graphical input, and songs may be identified that meet the desired criteria (e.g., are played by a single musician on a guitar).

Accordingly, example embodiments of the present invention provide items of musical content for presentation to a user in response to receiving graphical user inputs. The at least one memory and the computer program code may be configured to, with the processor, cause the apparatus to receive a graphical input provided by a user (e.g., a sketch 100 as described above and shown in FIG. 3), where the graphical input represents at least one musical element. The musical element may be a criterion selected by the user, such that musical content (e.g., songs) satisfying the criterion would be identified for presentation to the user. In some embodiments, the musical element may, for example, be a musical attribute that is related to a musician (e.g., a performer, such as a band member or members or a particular vocalist), a musical instrument associated with the music, or a musical style (e.g., a genre or type of music).

The at least one musical element represented by the graphical input 100 may be determined (e.g., via the gesture classifier 86 and the processor 70 of FIG. 2), and at least one item of musical content including the at least one musical element that is determined may be identified, such as by accessing a database or repository of musical content, as described in greater detail below. Embodiments may then provide for presentation of the at least one item of musical content to the user, such as by displaying a playlist 110 (shown in FIG. 3) that includes a description of the items (e.g., the title and/or artist for each song 120) identified and/or by playing one or more of the identified musical content items. Said differently, a playlist 110 may be created such that any item of musical content that does not satisfy the musical elements represented by the graphical input 100 is excluded from the playlist.

In the embodiment depicted in FIG. 3, the user wishes to hear music that is played by guitar and, thus, draws a picture of a guitarist 130. Embodiments of the at least one memory and the computer program code cause the apparatus 50 to analyze the graphical input 100 provided by the user in the form of the sketch and recognize it as a guitarist. As a results, a playlist 110 is created that contains music where a guitar is the dominant instrument or, in some embodiments, where a guitar is the only instrument (e.g., the music has no vocals or other instruments).

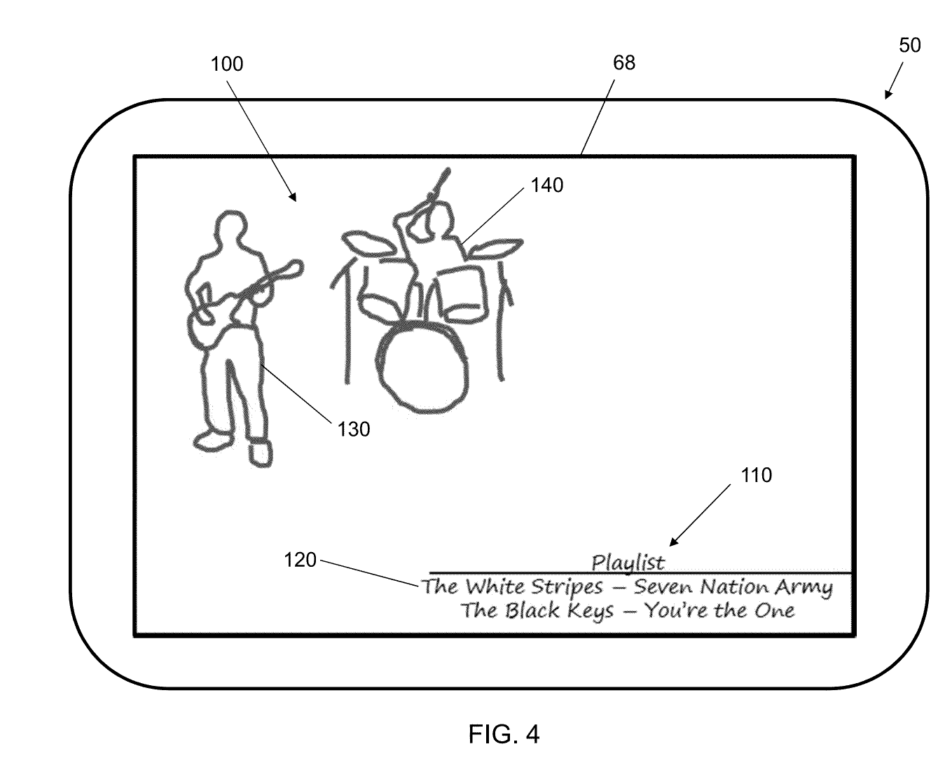

Continuing this example, and with reference to FIG. 4, the user may continue working on his drawing by adding a drummer 140 to the sketch 100. Again, the apparatus 50 may be caused (e.g., via the processor) to recognize the new portion of the sketch 100 as representing a drummer, and the previous playlist 110 shown in FIG. 3 may be deleted and replaced with a new playlist 110 shown in FIG. 4 that contains musical content items associated with guitars and drums. The new playlist 110 may, for example, include only songs 120 that feature guitar and drums as the dominant instruments, or, in other embodiments, may include only songs in which guitar and drums are the only instruments used to create the music.

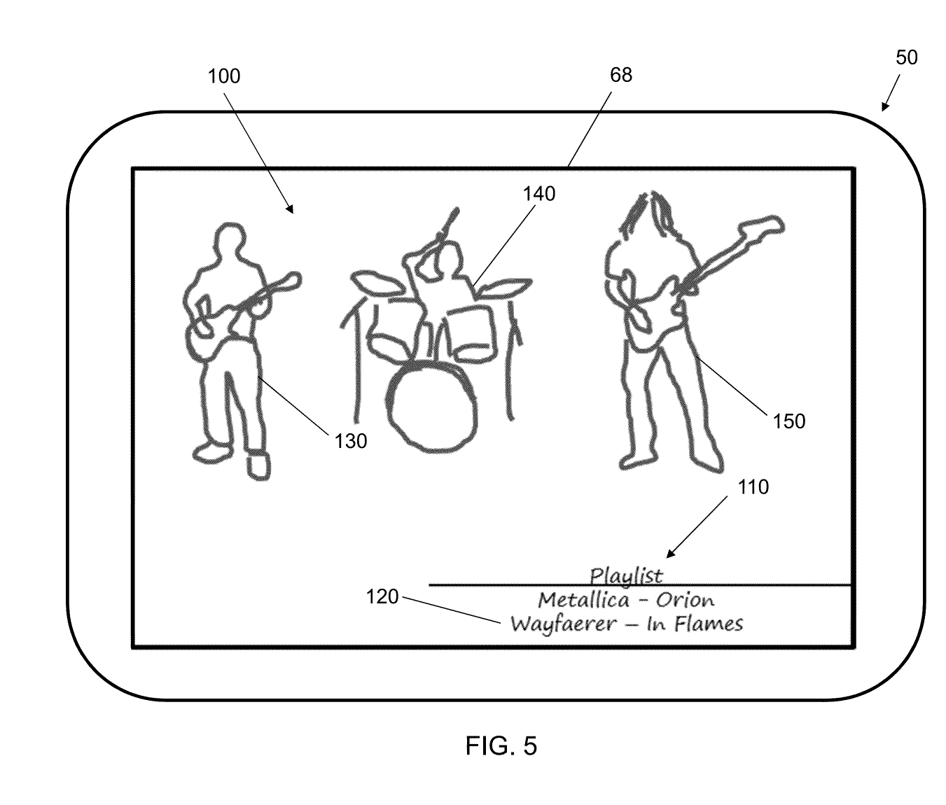

In FIG. 5, the user in this example has added yet another portion to his sketch 100—a bassist 150. Embodiments of the apparatus 50 may again be caused (e.g., via the processor) to recognize the new portion of the sketch 100 as representing a bassist, and the previous playlist 110 shown in FIG. 4 may be deleted and replaced with a new playlist 110 shown in FIG. 5 that contains musical content items 120 associated with guitars, drums, and bass. As noted above, the new playlist 110 may, for example, include only songs 120 that feature guitar, drums, and bass as the dominant instruments, or, in other embodiments, may include only songs in which guitar, drums, and bass are the only instruments used to create the music.

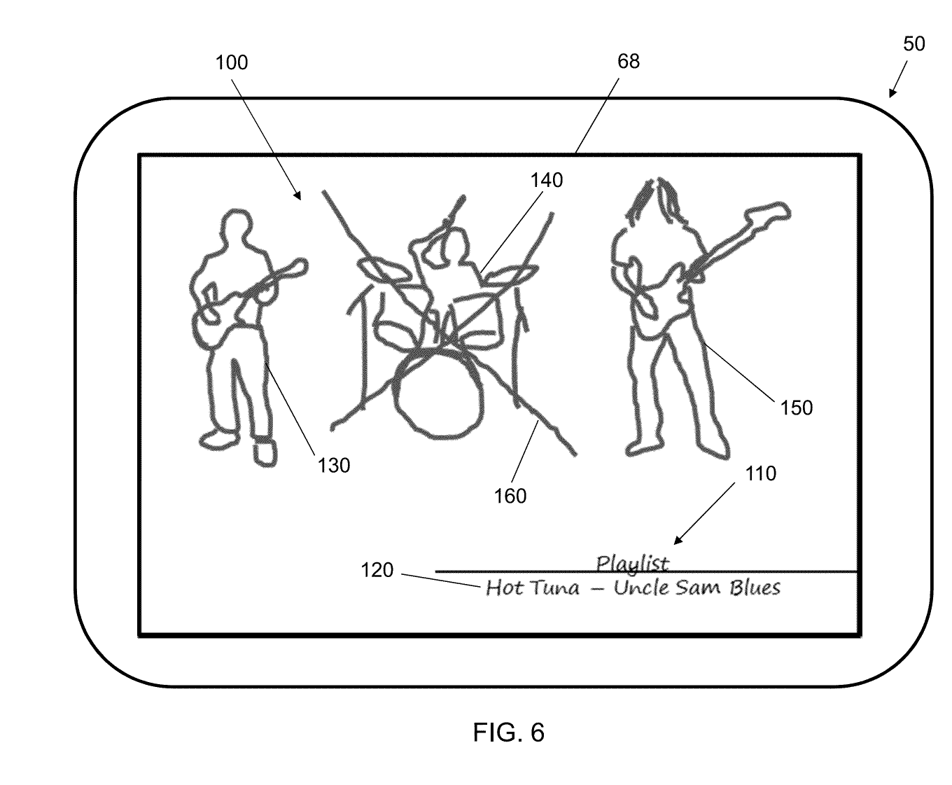

Thus, as depicted in the examples of FIGS. 3-5, in some embodiments, the at least one memory and the computer program code may be configured to, with the processor, cause the apparatus to receive the graphical input by receiving a modification of the graphical input provided by the user. In the examples described above and illustrated in FIGS. 3-5, the modification is the addition of new portions to the user's sketch 100, representing additional musical elements. In other cases, however, the user may remove one or more portions of the graphical input 100 representing musical elements that the user no longer wishes to be included in the musical content provided to him Such deletions may be accomplished by the user erasing portions of the sketch 100, or, as shown in FIG. 6, deletions may be represented by the user crossing out 160 (e.g., drawing an “X” over) one or more undesired portions of the sketch. In FIG. 6, for example, the user no longer wishes to get results in which the musical content items include a drummer 140 (or, at least, feature a drummer as a dominant portion of the content). As a result of the user's modification in FIG. 6 (e.g., crossing out the drummer 140), embodiments of the apparatus 50 may replace the previous playlist 110 with a new playlist 110 that no longer contains music featuring a drummer.

Although the examples above refer to graphical input representing musical elements in the form of musical instruments, in other examples, the represented musical elements may depict musicians or musical styles. For example, a particular performer, group of performers, or type of performer (e.g. female vocalist) may be represented by a user drawing a sketch of the face of the performer or group. The sketch may be otherwise associated with the musician or musical group. For example, the graphical input may be a caricature of a particular performer or group; a famous profile, posture, or pose of the performer or group; a trademark associated with the performer or group; or some other identifying symbol. For example, a man with oversized lips may represent Mick Jagger, whereas a scarf may represent Axl Rose.

In still other embodiments, the musical element represented by the graphical input may be a musical style, such as a genre or mood of music. For example, the user may draw a heart to represent romantic music or love songs; a bolt of lightning to represent aggressive or heavy metal rock music; a peace symbol to represent '70s Vietnam era rock music; etc. Multiple graphical inputs representing, for example, two musical styles may be provided by a user, and a playlist may be created that includes musical content that is considered a combination of the two represented styles. For example, a graphical input representing blues music and a graphical input representing jazz music may return musical content items that are considered blues jazz music, whereas a graphical input representing blues music and a graphical input representing rock music may return musical content items that are considered blues rock.

In some embodiments, the graphical input 100 may represent a dominance of the at least one musical element. Thus, in addition to representing at least one musical element that should be present in the items of musical content that are identified for presentation to the user, the graphical input 100 may also provide information with respect to the degree of presence of the musical element in the items of musical content (e.g., with respect to a baseline, predefined standard or relative to other musical elements represented by the graphical input). The dominance (e.g., the degree of presence) of the musical element may be indicated via different physical characteristics of the graphical input 100. For example, in some embodiments, the size of a portion of the graphical input 100 representing a particular musical element may indicate the dominance of that musical element.

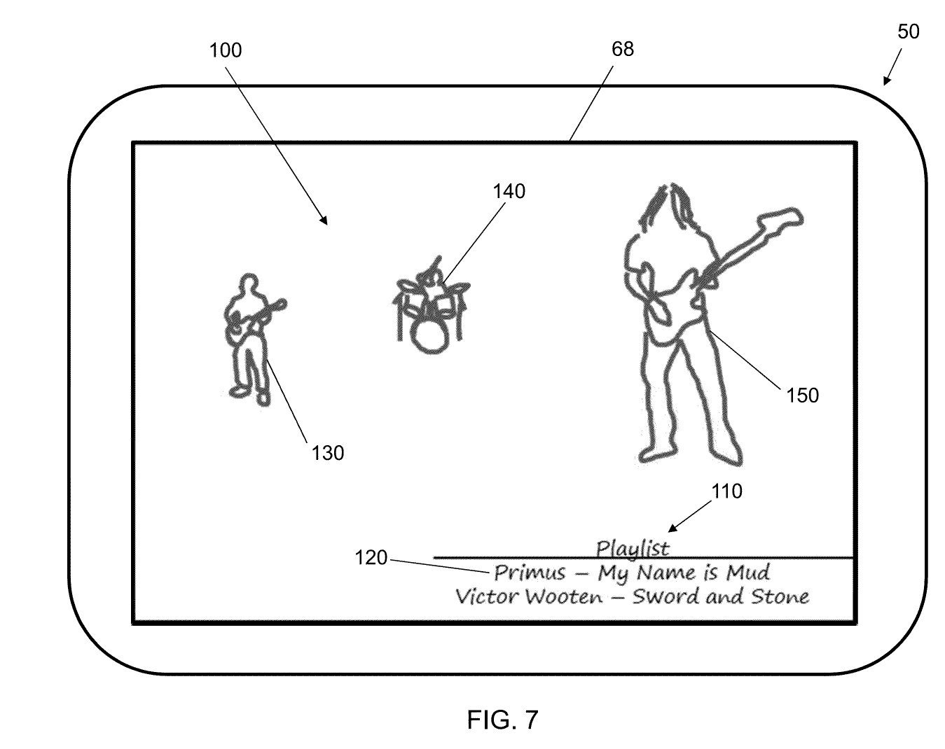

Turning to FIG. 7, for example, the user may be interested in musical content items that include guitar, drums, and bass sounds, but in which the bass is more dominant than the guitar and drums. Accordingly, the user may draw the bassist 150 relatively larger than the guitarist 130 and the drummer 140 to indicate the relative dominance as among the three musical elements represented. As a result of the graphical input 100 depicted in FIG. 7, the user may be provided with a playlist 110 of music that includes guitar, drums, and bass, but where the bass is the dominant instrument (such as music featuring bass solos).

In some embodiments, the size of the graphical input 100 or portion of the graphical input representing a particular musical element may be indicative of the dominance of the represented musical element without requiring comparison to the size of other portions of the graphical input. For example, in a case where the user only wishes to hear music featuring prominent guitar sounds, but is ambivalent as to what other instruments or musicians are featured, the user may provide a graphical input 100 that has only a large illustration of a guitarist (such as the guitarist 130 of FIGS. 3-7). In this regard, the size of the graphical input 100 as being “large” and indicating a dominance of the represented musical element may be determined based on the size of the graphical input with respect to the available sketching area (e.g., the size of the touch screen display 68). The size of the graphical input 100 or portion thereof may be the size that the user initially draws the sketch, or the size of an existing drawing may be adjusted by the user through subsequent user input, such as by the user scaling a portion of the drawing (e.g., by selecting a portion of the drawing and dragging it out from a center of the drawing to expand its size or dragging it in towards the center of the drawing to reduce its size, or by pinch zooming). The playlist 110 may be dynamically modified as a result of the user's subsequent input regarding dominance.

In other embodiments, the dominance of a depicted musical instrument may be represented by other characteristics of the graphical input 100 provided by the user. For example, the color of the graphical input 100 or a portion of the graphical input representing a particular musical element may be indicative of the dominance of the respective musical element. For example, in a case similar to that of FIG. 7, the user may use the color red to draw the bassist 150, whereas the guitarist 130 and drummer 140 may be drawn in black (or the colors may be modified or adjusted after the drawing is created to indicate the user's dominance preferences). In addition or instead of size and color, other characteristics of the graphical input that may be provided or varied to represent dominance may include highlighting, circling, etc. to demonstrate the user's preference for a certain represented musical element.

In some embodiments, the location on the display of a graphical input or a portion thereof may represent the dominance corresponding to that graphical input or portion. For example, instead of drawing the bassist larger as in FIG. 7, the user may draw or move the representation of the bassist higher up on the screen (e.g., with respect to a vertical axis of the display) than the drummer and guitarist, indicating that the bassist should have a higher dominance. Furthermore, the relative differences in the location on the display may indicate the relative dominance of the represented musical elements. For example, drawing the guitarist at the extreme bottom of the display might denote that the guitarist should have the least dominance, drawing or positioning the drawing of the drummer in the middle of the display might denote that the drummer should have a moderate dominance, and drawing the bassist at the top of the display may denote that the bassist should have the highest dominance of the three represented musical elements. Although this particular example considers a vertical axis of the display, positioning the graphical inputs with respect to a horizontal axis may also be used to indicate dominance. As yet another alternative, proximity to a particular location on the display, such as a center of the display, may indicate the dominance of the respective musical elements. In one embodiment, for example, graphical inputs closest to the center of the display may be associated with a higher dominance than those farther away from the center.

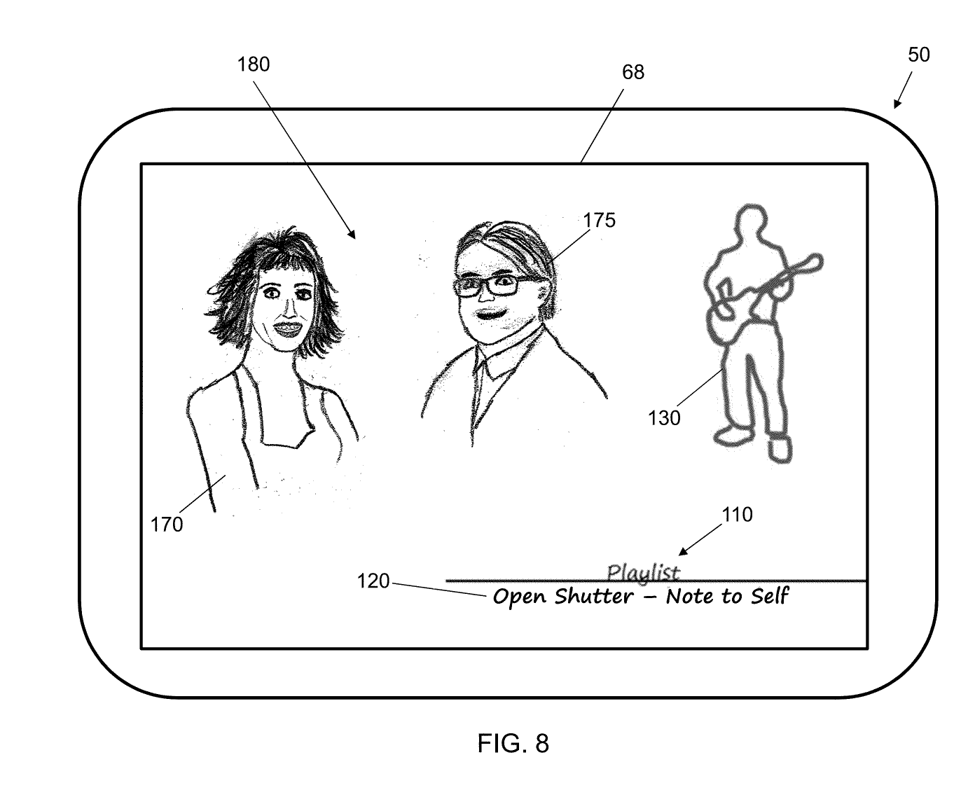

In some embodiments, the at least one memory and the computer program code may be further configured to, with the processor, cause the apparatus to provide for display of a graphical representation of at least one musical element of an initial item of musical content that is provided to the user. For example, the user may select a particular song to hear from a list of songs. The selected song may be associated with a system-generated graphical representation of at least one musical element that is present in the song. For example, the song may be a collaboration between two independent vocalists and may feature a guitar solo. In this example, a representation of each vocalist 170, 175, as well as a depiction of a guitarist 130, may be presented in the graphical representation 180 that is displayed when the user selects to hear the particular song 120, as shown in FIG. 8. The user, upon listening to the selected music, may decide to find out what other songs the two vocalists have worked on together, but may not care to limit the search to musical content items featuring the guitar. Accordingly, the user may cross out the guitarist 130 depicted in the graphical representation 180, and one or more items of musical content including the two depicted vocalists 170, 175 may be presented to the user as a result.

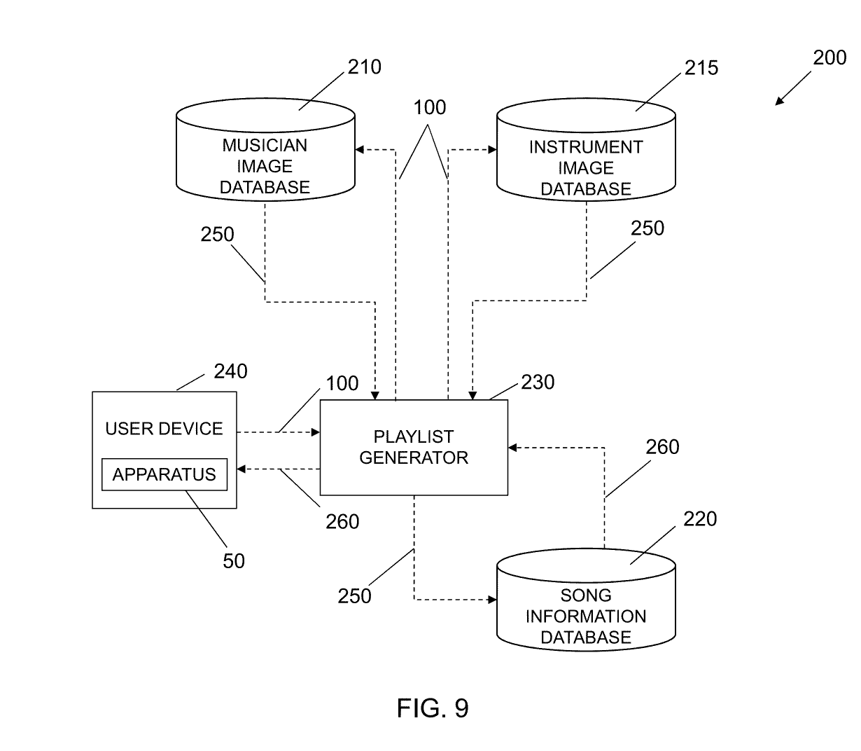

Items of musical content, such as music files, may be accessed and searched with respect to the graphical input received from the user, and the results may be provided to the user in various ways in accordance with embodiments of the inventions. With reference now to FIG. 9, for example, a system 200 for providing for presentation of one or more items of musical content may include a Musician Image Database 210, an Instrument Image Database 215, a Song Information Database 220, and a Playlist Generator 230 in communication with the Musician Image Database, the Instrument Image Database, the Song Information Database, and the User Device 240 (which may, in some cases, embody the apparatus 50 described above).

In this regard, data regarding musician images may be stored in the Musician Image Database 210, such as the potential renditions that may be drawn by a user and the artist or types of artists (e.g., name of the artist, gender, or style of artist) that the renditions may represent. The musician image data may be accessed by the apparatus 50 for determining the at least one musical element represented by the graphical input 100 provided by the user. For example, the apparatus 50 may access the Musician Image Database 210 (e.g., via the processor and/or the communication interface) and compare the graphical input 100 or portions thereof with the musician image data to identify whether a particular musician or type of musician (e.g., female vocalist) is represented by the graphical input.

Similarly, the Instrument Image Database 215 may be configured to store instrument image data, such as the shapes or potential renditions that may be drawn by a user and the instrument or instrument sounds that they may represent. Thus, the apparatus 50 may access the Instrument Image Database 215 and compare the graphical input 100 or portions thereof with the instrument image data to identify whether a particular instrument or type of instrumental sound (e.g., wood winds or percussion) is represented by the graphical input. As a further note, as the system is used by one or more users, the databases may collect different graphical depictions of musicians and/or musical instruments from the users and may learn the intended associations. In this way, the Instrument Image Database and the Musician Image Database may grow the more they are used.

The Song Information Database 220 may be a database that is configured to store a catalog of song information that can be searched by the apparatus 50 (directly or via the Playlist Generator 230) to identify items of musical content that satisfy the user's criteria as provided via the musical elements represented in the graphical input. In some embodiments, for example, each item of musical content (e.g., each song) may be associated with a content tag that describes the presence of certain instruments and/or the presence of certain musicians or types of musicians. The Song Information Database 220 or a database configured to communicate with the Song Information Database, such as an annotations database (not shown), may be provided, for example, that is configured to annotate music, such that the annotations facilitate the association of each item with one or more predefined content tags (e.g., via a tag classifier). In some cases, the annotations and tagging may be done automatically, such as by analyzing compact features of the music signal (e.g., mel-frequency cepstral coefficients) from an unknown piece of music and comparing it to a known signal to determine the musical elements included in the unknown piece. The tag classifier may then associate the corresponding content tags with that piece of music based on the analysis and comparison. Alternatively, manual annotation may be provided for, in which a group of musical experts annotate each item of musical content stored in the Song Information Database 220 so as to facilitate the association of appropriate content tags by the tag classifier (which association may be done automatically based on the manual annotations).

Moreover, in some cases, the items of musical content may be further analyzed and annotated such that the content tags associated with the items may include an indication of the dominance of each musician or instrument that is identified. For example, a prominence value may be assigned to each content tag that is an indication of the confidence of the tag classifier that the tagged musician or instrument is present in the item of musical content. Such confidence may be based on how loud the particular musician or instrument sound is with respect to other sounds in the item of musical content, the relative duration of the identified sounds with respect to the duration of the music as a whole, etc.

Accordingly, with continued reference to FIG. 9, the graphical input 100 may be provided by the apparatus 50 to the Playlist Generator 230, which may in turn query the Musician Image Database 210 and/or the Instrument Image Database 215 to determine the one or more musical elements represented by the graphical input and provide corresponding input tags 250 that can be used to identify the appropriate items of musical content. In some cases, the apparatus 50 may be configured to query the Musician Image Database 210 and/or the Instrument Image Database 215 directly and provide the obtained input tags 250 to the Playlist Generator for identifying the items of musical content. For example, the apparatus 50 (e.g., via the gesture classifier 86 and/or the processor 70) may associate the input tags 250 obtained from the Musician Image Database 210 and/or the Instrument Image Database 215 with the graphical input 100 provided by the user to describe the musical elements represented. In either case, the input tags 250 corresponding to the musical elements represented by the graphical input 100 may then be used to query the Song Information Database 220 and identify items of musical content including the musical elements represented. In this regard, the input tags 250 may be compared with the content tags 260 that are associated with each item of musical content stored in the Song Information Database 220, and items with matching content tags may be selected for presentation to the user.

In some embodiments, other databases holding musician image data, instrument image data, or song information maybe be accessed (e.g., directly or indirectly via one or more of the system components described above) to search for musical content. An example of such a database may be Wikipedia.

Thus, as described above, the at least one memory and the computer program code may be configured to, with the processor, cause the apparatus to identify the at least one item of musical content by accessing a database configured to store a plurality of items of musical content (e.g., the Song Information Database 220 described above) and matching an input tag 250 associated with a musical element represented by the graphical input 100 with a content tag 260 associated with the at least one item of musical content stored in the database. Furthermore, in a case where the dominance of a represented musical element is considered, the prominence value associated with each content tag 260 may be compared with the dominance indication associated with the corresponding input tag 250 such that the search is able to match both the desired musical elements and their desired proportions and will return results that satisfy both sets of criteria.

In addition to providing for presentation of one or more items of musical content to a user, such as by creating and displaying a playlist for the user to review and consume, embodiments of the invention may allow a user to share graphical inputs with each other (effectively sharing the resulting playlists). Thus, in some embodiments, the at least one memory and the computer program code may be configured to, with the processor, cause the apparatus to provide for communication of the graphical input and the at least one item of musical content identified to a remote device, such as another user's device. This may, in turn, allow the recipient of the graphical input to modify the received playlist content by modifying the graphical input (e.g., by adding or removing portions of the sketch). In addition, multiple users may be able to create a single graphical input in a collaborative way via sharing of partially completed graphical inputs. For example, one user may create one object or character in a graphical input and send the graphical input to another user, who may add another object or character, which would allow several users to influence the type of music to be provided. The result may be a party playlist that is presented to all of the collaborating users to enjoy.

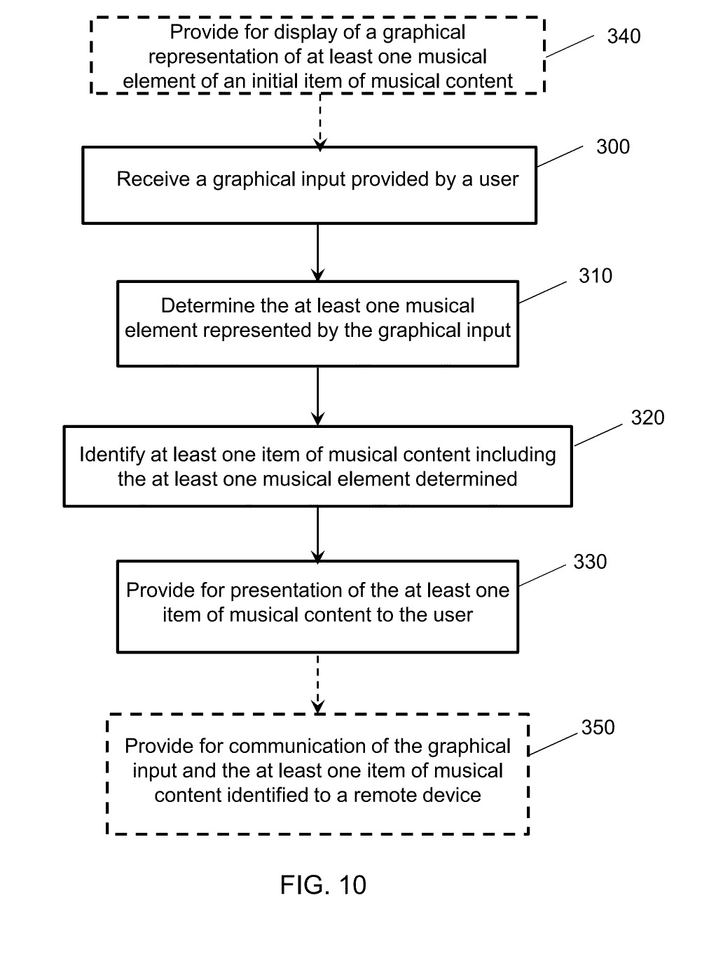

FIG. 10 illustrates flowcharts of systems, methods, and computer program products according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an example embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one example embodiment of a method for providing items of musical content for presentation to a user is shown in FIG. 10. FIG. 10 depicts an example embodiment of a method for providing items of musical content for presentation to a user that includes receiving a graphical input provided by a user at block 300, wherein the graphical input represents at least one musical element. The at least one musical element represented by the graphical input is determined at block 310, and at least one item of musical content is identified at block 320 including the at least one musical element determined. Presentation of the at least one item of musical content to the user is provided for at block 330. Presentation of the at least one item of musical content may, for example, include the displaying of a playlist.

In some example embodiments, the at least one musical element may comprise a musician, a musical instrument, or a musical style, as described above. The graphical input may also represent a dominance of the at least one musical element.

The graphical input may be received by receiving a modification of the graphical input provided by the user, as described above. In some embodiments, display of a graphical representation of at least one musical element of an initial item of musical content that is provided to the user may be provided for at block 340, and receiving the graphical input may comprise receiving a modification of the graphical representation. A database configured to store a plurality of items of musical content may, in some cases, be accessed, and an input tag associated with a musical element represented by the graphical input may be matched with a content tag associated with the at least one item of musical content stored in the database to identify the item(s) of musical content. Moreover, communication of the graphical input and the at least one item of musical content identified to a remote device may be provided for at block 350.

In some embodiments, certain ones of the operations above may be modified or further amplified as described below. Furthermore, in some embodiments, additional optional operations may be included, some examples of which are shown in dashed lines in FIG. 10. Modifications, additions, or amplifications to the operations above may be performed in any order and in any combination.

In an example embodiment, an apparatus for performing the method of FIG. 10 above may comprise a processor (e.g., the processor 70 of FIG. 2) configured to perform some or each of the operations (300-350) described above. The processor may, for example, be configured to perform the operations (300-350) by performing hardware implemented logical functions, executing stored instructions, or executing algorithms for performing each of the operations. Alternatively, the apparatus may comprise means for performing each of the operations described above. In this regard, according to an example embodiment, examples of means for performing at least portions of operations 320 and 350 may comprise, for example, the communication interface 74, the processor 70, the memory device 76, and/or a device or circuit for executing instructions or executing an algorithm for processing information as described above. Examples of means for performing operations 300, 330, and 340 may comprise, for example, the user interface transceiver 72, the processor 70, the memory device 76, and/or a device or circuit for executing instructions or executing an algorithm for processing information as described above. Examples of means for performing operation 310 may comprise, for example, the processor 70 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
receive a graphical input provided by a user, wherein the graphical input represents at least one musical element;
determine the at least one musical element represented by the graphical input;
identify at least one item of musical content including the at least one musical element determined; and
provide for presentation of the at least one item of musical content to the user.

2. The apparatus of claim 1, wherein the at least one musical element comprises a musician, a musical instrument, or a musical style.

3. The apparatus of claim 1, wherein the graphical input represents a dominance of the at least one musical element.

4. The apparatus of claim 1, wherein the at least one memory and the computer program code are configured to, with the processor, cause the apparatus to identify the at least one item of musical content by accessing a database configured to store a plurality of items of musical content and matching an input tag associated with a musical element represented by the graphical input with a content tag associated with the at least one item of musical content stored in the database.

5. The apparatus of claim 1, wherein the at least one memory and the computer program code are configured to, with the processor, cause the apparatus to provide for the presentation of the at least one item of musical content by displaying a playlist.

6. The apparatus of claim 1, wherein the at least one memory and the computer program code are configured to, with the processor, cause the apparatus to receive the graphical input by receiving a modification of the graphical input provided by the user.

7. The apparatus of claim 1, wherein the at least one memory and the computer program code are further configured to, with the processor, cause the apparatus to provide for display of a graphical representation of at least one musical element of an initial item of musical content that is provided to the user, wherein receiving the graphical input comprises receiving a modification of the graphical representation.

8. The apparatus of claim 1, wherein the at least one memory and the computer program code are further configured to, with the processor, cause the apparatus to provide for communication of the graphical input and the at least one item of musical content identified to a remote device.

9. A method comprising:
receiving a graphical input provided by a user, wherein the graphical input represents at least one musical element;
determining, via a processor, the at least one musical element represented by the graphical input;
identifying at least one item of musical content including the at least one musical element determined; and
providing for presentation of the at least one item of musical content to the user.

10. The method of claim 9, wherein the graphical input represents a dominance of the at least one musical element.

11. The method of claim 9, wherein identifying the at least one item of musical content comprises accessing a database configured to store a plurality of items of musical content and matching an input tag associated with a musical element represented by the graphical input with a content tag associated with the at least one item of musical content stored in the database.

12. The method of claim 9, wherein providing for the presentation of the at least one item of musical content comprises displaying a playlist.

13. The method of claim 9, wherein receiving the graphical input comprises receiving a modification of the graphical input provided by the user.

14. The method of claim 9 further comprising providing for display of a graphical representation of at least one musical element of an initial item of musical content that is provided to the user, wherein receiving the graphical input comprises receiving a modification of the graphical representation.

15. The method of claim 9 further comprising providing for communication of the graphical input and the at least one item of musical content identified to a remote device.

16. A computer program product comprising at least one computer-readable storage medium having computer-executable program code portions stored therein, the computer-executable program code portions comprising program code instructions for:
receiving a graphical input provided by a user, wherein the graphical input represents at least one musical element;
determining the at least one musical element represented by the graphical input;
identifying at least one item of musical content including the at least one musical element determined; and
providing for presentation of the at least one item of musical content to the user.

17. The method of claim 16, wherein computer program portions for identifying the at least one item of musical content are further configured for accessing a database configured to store a plurality of items of musical content and matching an input tag associated with a musical element represented by the graphical input with a content tag associated with the at least one item of musical content stored in the database.

18. The computer program product of claim 16, wherein computer program portions for receiving the graphical input are further configured for receiving a modification of the graphical input provided by the user.

19. The computer program product of claim 16 further comprising computer program portions configured for providing for display of a graphical representation of at least one musical element of an initial item of musical content that is provided to the user, wherein receiving the graphical input comprises receiving a modification of the graphical representation.

20. The computer program product of claim 16 further comprising computer program portions configured for providing for communication of the graphical input and the at least one item of musical content identified to a remote device.
